(19) United States
(12) Patent Application Publication
(10) Pub. No.: US 2026/0091541 A1
(43) Pub. Date: Apr. 2, 2026

(54) METHOD FOR MANUFACTURING A PLASTIC WEB FOR THE PRODUCTION OF A TRIM PANEL

(71) Applicant: MATERI'ACT, Nanterre (FR)

(72) Inventors: Benjamin QUESNEL, VALENCIA (ES); Nadège DRIEUX, MARIAC (FR)

(21) Appl. No.: 19/340,117

(22) Filed: Sep. 25, 2025

(30) Foreign Application Priority Data
Sep. 27, 2024 (FR) 24 10385

(51) Int. Cl. B29C 48/00; B29C 48/08; B29C 48/21; B29C 48/885; B29K 23/00; B29K 105/00; B29K 105/26; B29L 9/00; B29L 31/30; B62D 29/04

(52) U.S. Cl. CPC B29C 48/022; B29C 48/08; B29C 48/21; B29C 48/885; B62D 29/043; B29K 2023/0633; B29K 2023/12; B29K 2105/251; B29K 2105/26; B29K 2995/007; B29L 2009/00; B29L 2031/3041

(57) ABSTRACT

A method for manufacturing a plastic web includes a step of hot extrusion of thermoplastic particles. The thermoplastic particles comprise polyolefin particles that are selected from: thermoplastic polyolefin (TPO) particles; thermoplastic vulcanized polyolefin (TPV) particles; thermoplastic elastomer polyolefin (TPE) particles; and a mixture of all or some of these particles. A quantity of polyolefin particles is between 50% and 96% by weight, relative to a total weight of thermoplastic particles, the polyolefin particles being at least partially derived from recycled materials.

### CROSS-REFERENCE TO RELATED APPLICATION

This application is a U.S. non-provisional application claiming the benefit of French Application No. 24 10385, filed on Sep. 27, 2024, which is incorporated herein by reference in its entirety.

### TECHNICAL FIELD

The present disclosure relates to a method for manufacturing a plastic web that includes a step of hot extrusion of thermoplastic particles. The thermoplastic particles may comprise polyolefin particles selected from: thermoplastic polyolefin (TPO) particles; thermoplastic vulcanized polyolefin (TPV) particles; thermoplastic elastomer polyolefin (TPE) particles; and a mixture of all or some of these particles; an amount of polyolefin particles being between 50% and 96% by weight relative to a total weight of thermoplastic particles, the polyolefin particles being at least partially derived from recycled materials.

The disclosure is particularly applicable to the production of interior trim panels for vehicles, especially motor vehicles.

### BACKGROUND

In order to reduce the environmental impact of vehicles, it is known to incorporate recycled materials into such panels. Document KR101946418 (D3) describes the manufacture of a composite panel incorporating TPOs from recycled materials.

However, the use of recycled materials presents difficulties in implementation, due to the impurities that may remain in the materials. In particular, the extrusion of TPO from recycled materials frequently results in webs with surface defects, especially elongation defects.

Furthermore, recycled materials can retain traces of volatile organic compounds, which impart an unpleasant odor to the resulting products. This makes the recycled materials problematic to integrate into a vehicle interior.

### SUMMARY

The disclosure proposes a method for manufacturing a plastic web that can remedy the above-mentioned problems. To this end, the disclosure provides a manufacturing method of the aforementioned type, wherein: in the case where the polyolefin particles comprise thermoplastic polyolefin (TPO) particles, the melt flow index (MFI) of said thermoplastic polyolefin particles is between 0.3 g and 10 g/10 min; in the case where the polyolefin particles comprise thermoplastic vulcanized polyolefin (TPV) particles, the melt flow index (MFI) of said thermoplastic vulcanized polyolefin particles is between 10 g and 30 g/10 min; and in the case where the polyolefin particles comprise thermoplastic elastomer polyolefin (TPE) particles, the hardness of said thermoplastic elastomer polyolefin particles is between 45 and 65 Shore A.

Such melt flow indexes or hardnesses make it possible, in particular, to sufficiently reduce surface defects in the web obtained by extrusion.

According to other advantageous aspects of the disclosure, the manufacturing method comprises one or more of the following features, taken alone or in any technically feasible combination:
prior to the extrusion step, the method comprises a treatment step, wherein the polyolefin particles are subjected to a flow of air at a temperature of between 50° C. and 150° C., preferentially between 100° C. and 120° C.;
the polyolefin particles comprise thermoplastic polyolefin (TPO) particles, optionally mixed with thermoplastic vulcanized polyolefin (TPV) particles and/or thermoplastic elastomer polyolefin (TPE) particles; —the thermoplastic particles further comprise polypropylene particles, preferably at least partially derived from recycled materials, an amount of said polypropylene particles preferably being between 5% and 40% by weight relative to a total weight of the thermoplastic particles, said polypropylene particles preferably having a melt flow index of between 0.5 g and 12.0 g/10 min, and a density of between 0.80 and 0.95 g/cm³;
the thermoplastic particles further comprise low density polyethylene (LDPE) particles, preferably at least partially derived from recycled materials, an amount of said LDPE particles preferably being between 15% and 30% by weight with respect to a total weight of the thermoplastic particles, said LDPE particles preferably having a melt flow index between 0.3 g and 12.0 g/10 min, and a density between 0.80 and 0.95 g/cm³;

The disclosure further relates to a plastic web derived from a method as described above.

In one embodiment, the plastic web has a thickness of between 0.2 mm and 1.5 mm and/or a density of at least 0.8 g/cm³.

The disclosure further relates to a vehicle trim panel, comprising a substrate, a first support layer and a second protective layer, the first support layer being arranged between the substrate and the second protective layer, the first support layer being formed from a plastic web as described above.

According to other advantageous aspects of the disclosure, the manufacturing method comprises one or more of the following features, taken alone or in any technically feasible combination:
the second protective layer has a thickness of between 5 μm and 50 μm;
the second protective layer is formed from a polyurethane (PU) or thermoplastic polyurethane (TPU) material, an acrylic, or a mixture of these compounds;
the trim panel further comprises: a third layer of polyolefin foam, arranged between the first support layer and the substrate; and preferentially a fourth layer arranged between the third layer of polyolefin foam and the substrate, said fourth layer being made of woven or non-woven textile.

### BRIEF DESCRIPTION OF THE DRAWINGS

The disclosure will be better understood on reading the following description, given solely by way of non-limiting example, and referring to the drawings in which:

FIG. 1 is a partial schematic view of a trim panel according to one embodiment of the disclosure; and

FIG. 2 is a schematic view of a step of a method for manufacturing the trim panel shown in FIG. 1.

### DETAILED DESCRIPTION

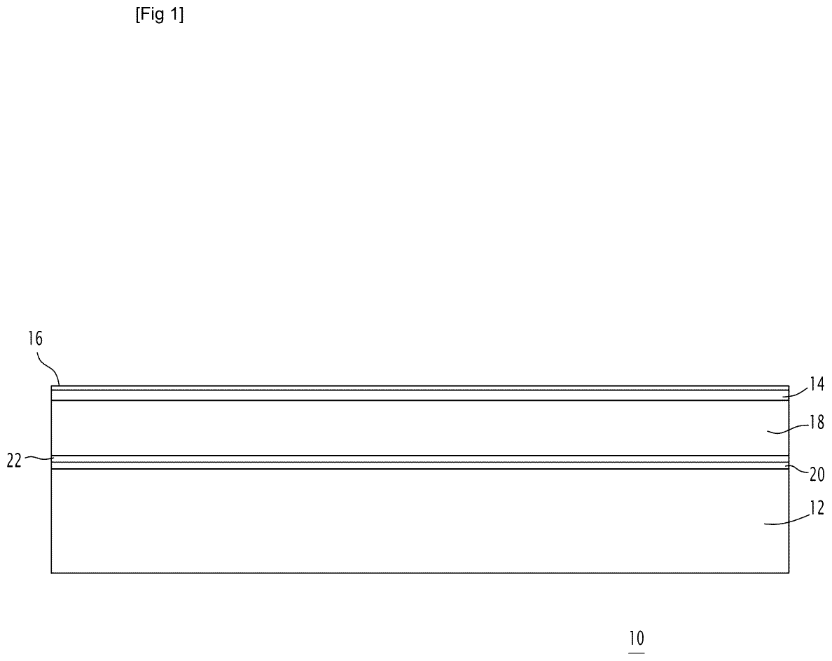

FIG. 1 shows a trim panel 10 according to one embodiment of the disclosure. The panel 10 is typically intended to be installed on board a vehicle, for example a motor vehicle, a train, a boat or any other vehicle.

The motor vehicle is, for example, a car, a utility vehicle, a truck, etc.

The panel 10 comprises a substrate 12, a first support layer 14, and a second protective layer 16. The first support layer 14 is arranged between the substrate 12 and the second protective layer 16.

Optionally, the panel 10 further comprises a third polyolefin foam layer 18 and/or a fourth textile layer 20 and/or a fifth anchoring layer 22. In the embodiment shown, the panel 10 comprises third 18, fourth 20 and fifth 22 layers. In a variant not shown, the panel comprises only one or some of said layers.

The substrate 12 is a rigid substrate, for example made of acrylonitrile-butadiene-styrene (ABS)-type material. Alternatively, the substrate 12 is made of a natural fiber-reinforced composite material, such as natural fiber-reinforced polypropylene (NFPP).

The first support layer 14 comprises polyolefins. Said polyolefins are selected from: thermoplastic polyolefins (TPO); thermoplastic vulcanized polyolefins (TPV); thermoplastic elastomer polyolefins (TPE); and a blend of all or some of these polyolefins.

Said TPO and/or TPV and/or TPE are at least partially derived from recycled materials.

A percentage of polyolefins in the first support layer 14 is between 50% and 96% by weight with respect to a total weight of said first layer 14.

In the case where the polyolefins of the first support layer 14 comprise thermoplastic vulcanized polyolefins (TPVs), said TPVs are, for example, of the EPDM rubber type.

If the polyolefins in the first support layer 14 comprise thermoplastic elastomer polyolefins (TPEs), said TPEs are preferentially used in blends with TPOs and/or TPVs.

In one embodiment of the disclosure, the polyolefins in the first support layer 14 comprise TPOs, optionally mixed with TPVs and/or TPEs.

In one embodiment, the first support layer 14 also comprises at least one polypropylene (PP). Preferentially, the at least one polypropylene is at least partially derived from recycled materials. A percentage of PP in the first support layer 14 is preferentially between 5% and 40% by weight, more preferentially between 10% and 30% by weight, relative to a total weight of said first support layer 14.

In one embodiment, the first support layer 14 also comprises at least one low-density polyethylene (LDPE). Preferentially, the at least one LDPE is at least partially derived from recycled materials. A percentage of LDPE in the first support layer 14 is preferentially between 15% and 30% by weight, more preferentially equal to about 20% by weight, relative to a total weight of said first support layer 14.

In one embodiment, the first support layer 14 additionally comprises additives such as pigments or colorants, UV stabilizers, odor-absorbing components or flame retardants, in an amount of less than 10% by weight, and preferably between 4 and 6% by weight.

In one embodiment, the first support layer 14 further comprises materials of natural origin, such as short fibers or fillers.

Preferably, the first support layer 14 has a thickness of between 0.2 mm and 1.5 mm. Preferably, the first support layer 14 has a density of at least 0.8 g/cm³.

According to an embodiment not shown, the panel 10 comprises several first support layers 14 as described above, superimposed on one another.

The second protective layer 16 is designed to form a surface layer for the panel 10. In the embodiment shown, one side of the first support layer 14 is in contact with one side of the second protective layer 16.

Preferably, the second protective layer 16 has a thickness of between 5 μm and 50 μm.

Preferably, the second protective layer 16 is formed from a polyurethane (PU) or thermoplastic polyurethane (TPU) material, an acrylic, or a mixture of these compounds. Preferably, said material has a viscosity of between 200 and 700 mPa·s (Brookfield, 25° C.).

In the embodiment shown, the third polyolefin foam layer 18 is arranged between the first support layer 14 and the substrate 12. More specifically, in the embodiment shown, one side of the first support layer 14 is in contact with one side of the third polyolefin foam layer 18.

Preferably, the third polyolefin foam layer 18 is made of material of the polypropylene type. More preferentially, said material is at least partially derived from recycled materials.

Preferably, the third polyolefin foam layer 18 has a thickness of between 0.2 mm and 2.5 mm. Preferably, the third polyolefin foam layer 18 has a density of at least 45 kg/m³, preferably between 50 and 70 kg/m³. Preferably, the third polyolefin foam layer 18 has a 25% compression ratio of between 80 and 160 kPa, according to ISO 3386-1.

Preferably, the fourth textile layer 20 is a non-woven textile or Jersey-knit fabric. Preferably, the fourth textile layer 20 has a thickness of between 0.2 mm and 3 mm.

In the embodiment shown, the fourth textile layer 20 is arranged between the third polyolefin foam layer 18 and the substrate 12. More precisely, in the embodiment shown, the fourth textile layer 20 is in contact with the substrate 12.

The fifth anchoring layer 22 is formed from a polyurethane (PU) or thermoplastic polyurethane (TPU) material, an acrylic, or a mixture of these compounds. Preferably, said material has a viscosity of between 200 and 700 mPa·s (Brookfield, 25° C.). Preferably, the fifth anchoring layer 22 has a thickness of between 3 μm and 10 μm, preferentially around 5 μm.

In the embodiment shown, the fifth anchoring layer 22 is arranged between the third polyolefin foam layer 18 and the substrate 12. More specifically, in the embodiment shown, the fifth anchoring layer 22 is in contact with the third polyolefin foam layer 18 and the fourth textile layer 20.

In a variant not shown, the panel 10 comprises only one or other of the fourth textile layer 20 and the fifth anchoring layer 22, in contact with both the third polyolefin foam layer 18 and the substrate 12.

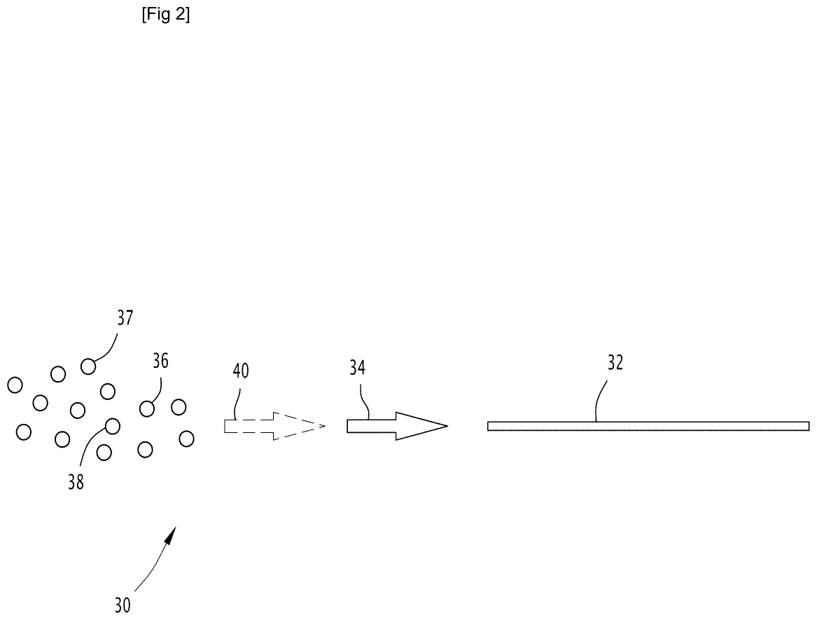

FIG. 2 schematically shows a method 30 for manufacturing a plastic web 32, said web 32 being used to form the first support layer 14.

The method 30 comprises a step 34 of hot extrusion of thermoplastic particles 36, 37, 38.

The thermoplastic particles 36, 37, 38 comprise polyolefin particles 36. The polyolefin particles 36 are selected from: thermoplastic polyolefin (TPO) particles; thermoplastic vulcanized polyolefin (TPV) particles; thermoplastic elastomer polyolefin (TPE) particles; and a mixture of all or some of these particles.

A quantity of polyolefin particles 36 is between 50% and 96% by weight, relative to a total weight of thermoplastic particles 36, 37, 38.

The thermoplastic particles 36, 37, 38 further comprise particles 37, 38 formed from other compounds used in the composition of the first layer 14 described above, such as polypropylenes and/or low-density polyethylenes.

The thermoplastic particles 36, 37, 38 are at least partly derived from recycled materials. In particular, the polyolefin particles 36 are at least partially derived from recycled materials.

In the case where the polyolefin particles 36 comprise TPO particles, the melt flow index (MFI) of said TPO particles is between 0.3 g and 10 g/10 min, more preferentially between 0.5 and 2 g/10 min.

In the case where the polyolefin particles 36 comprise TPV particles, the melt flow index (MFI) of said TPV particles is between 10 g and 30 g/10 min.

In the case where polyolefin particles 36 comprise TPE particles, the hardness of said TPE particles is between 45 and 65 Shore A, preferentially between 50 and 60 Shore A, more preferentially around 55 Shore A.

In the case where the thermoplastic particles 36, 37, 38 comprise polypropylene (PP) particles 37, an amount of said polypropylene particles is preferably between 5% and 50% by weight with respect to a total weight of the thermoplastic particles, and said polypropylene particles preferably have a melt flow index between 0.5 g and 12.0 g/10 min, and a density between 0.80 and 0.95 g/cm³.

In the case where the thermoplastic particles 36, 37, 38 comprise low-density polyethylene (LDPE) particles 38, an amount of said LDPE particles is preferably between 5% and 25% by weight with respect to a total weight of the thermoplastic particles, and said polypropylene particles preferably have a melt flow index between 0.3 g and 12.0 g/10 min, and a density between 0.80 and 0.95 g/cm³.

The melt flow indexes given above are based on measurements carried out in accordance with ISO 1133, with a 2.16 kg piston and at a temperature of 190° C.

Preferentially, step 34 of hot extrusion of thermoplastic particles 36, 37, 38 is carried out at a temperature of between 150° C. and 250° C., more preferentially between 190° C. and 220° C.

The above-mentioned melt flow indexes of particles 36, 37, 38 result in a web 32 with a smooth surface, free from elongation defects.

In one embodiment, prior to the extrusion step 34, the method 30 comprises a step 40 of treating particles 36, 37, 38.

Preferably, during the treatment step 40, the particles 36, 37, 38 are subjected to a flow of air at a temperature of between 90° C. and 160° C., preferentially between 130° C. and 150° C.

Preferably, the duration of treatment step 40 is between 30 min and 180 min.

Such a treatment step 40 removes from the particles 36, 37, 38 certain volatile compounds that remain in said particles after the material recycling steps. The web 32 then obtained by extrusion is thus free of unpleasant odors, enabling it to be used in the manufacture of vehicle interior fittings.

A method for creating the trim panel 10 from the web 32 will now be described.

In one embodiment, the web 32 is laminated onto a layer of polypropylene foam, the precursor to the third layer 18. The resulting assembly, together with a precursor film to the second protective layer 16, is vacuum-bonded to the substrate 12. The trim panel 10 described above is thus obtained.

Optionally, the polypropylene foam layer, a precursor to the third layer 18, is joined to the fourth 20 and/or fifth 22 layers before or after the lamination step described above.

All or part (14,16,18,20) of such a trim panel 10 can be recycled by shredding, without the need for a layer separation step.

### EXAMPLES

### Example 1: Formulations

[Table 1] Table 1 shows formulations produced by hot extrusion of a mixture comprising particles 36 of thermoplastic polyolefins (TPO), particles 37 of polypropylene (PP) and particles 38 of low-density polyethylene (LDPE) as described above. The percentages are expressed as the weight of each component in relation to the total weight of the formulation.

TABLE 1

| | Formulation | Formulation | Formulation |
|---|---|---|---|
| | 1 | 2 | 3 |
| 36 (TPOs) | 58% | 67% | 86% |
| 37 (PPs) | 19% | 29% | 10% |
| 38 (LDPEs) | 19% | — | — |
| additives and/or | 4% | 4% | 4% |
| fillers | | | |

Preferably, the TPO particles 36 and/or PP particles 37 and/or LDPE particles 38 are at least partially made from recycled materials.

Each of the formulations 1, 2 and 3 produces a web 32 as described above, which can be used to manufacture a panel 10 as described above.

### Example 2: Particle Treatment

A batch of PP particles 37 and a batch of LDPE particles 38, at least partially derived from recycled materials, are supplied to produce the formulations 1 to 3 described in Example 1 above.

Prior to the hot extrusion step in Example 1, first samples A1.1, A1.2, A1.3 of PP particle batch 37, and second samples A2.1, A2.2, A2.3 of LDPE particle batch 38, are subjected to the anti-odor treatment step 40: the particles are exposed to an air stream at a temperature of 145° C. for 180 min.

In addition, control samples B1.1, B1.2, B1.3 of PP particle batch 37, and control samples B2.1, B2.2, B2.3 of LDPE particle batch 38, are produced without the anti-odor treatment.

The above samples are then subjected to an odor test in accordance with VDA protocol 270 (05-2022)-1,2,3 B.

More specifically, samples are subjected to the following conditions:
Ai.1 and Bi.1:24 hours in water at 23° C.;
Ai.2 and Bi.2:24 hours in water at 40° C.;
Ai.3 and Bi.3:2 hours in dry conditions at 80° C.

The samples are evaluated by different testers, according to the following scale:
Level 1: No perceptible odor
Level 2: Slightly perceptible odor, not bothersome
Level 3: Clearly perceptible odor, not bothersome
Level 4: Bothersome odor
Level 5: Highly bothersome odor
Level 6: Unacceptable odor level.

[Table 2] Table 2 shows the results obtained:

TABLE 2

| Treated/control | Treated | Control |
|---|---|---|
| sample | sample result | result |
| A1.1/B1.1 (PP) | 2 | 3.5 |
| A1.2/B1.2 (PP) | 2.5 | 4.5 |
| A1.3/B1.3 (PP) | 3.5 | 6 |
| A2.1/B2.1 (LDPE) | 2.5 | 3 |
| A2.2/B2.2 (LDPE) | 3 | 3.5 |
| A2.2/B2.1 (LDPE) | 3 | 4.5 |

Whatever the conditions chosen for the odor test, the above results show that the anti-odor treatment is effective in bringing PP particle 37 and LDPE particle 38 to an acceptable odor level for use in a motor vehicle interior trim panel.

The disclosure has been illustrated and described in detail in the drawings and the preceding description. This must be considered as illustrative and given by way of example and not as limiting the disclosure to this description alone. Many alternative embodiments are possible.

1. A method for manufacturing a plastic web comprising:
a step of hot extrusion of thermoplastic particles;
the thermoplastic particles comprising polyolefin particles, the polyolefin particles being selected from: thermoplastic polyolefin (TPO) particles; thermoplastic vulcanized polyolefin (TPV) particles; thermoplastic elastomer polyolefin (TPE) particles; and a mixture of all or some of these particles;
a quantity of polyolefin particles being between 50% and 96% by weight, relative to a total weight of thermoplastic particles,
the polyolefin particles being at least partially derived from recycled materials,
the method being characterized in that:
in a case where the polyolefin particles comprise thermoplastic polyolefin (TPO) particles, a melt flow index (MFI) of the thermoplastic polyolefin particles is between 0.3 g and 10 g/10 min;
in a case where the polyolefin particles comprise thermoplastic vulcanized polyolefin (TPV) particles, the melt flow index (MFI) of the thermoplastic vulcanized particles is between 10 g and 30 g/10 min; and
in a case where the polyolefin particles comprise thermoplastic elastomer polyolefin (TPE) particles, a hardness of the thermoplastic elastomer polyolefin particles is between 45 and 65 Shore A.

2. The method according to claim 1, wherein, prior to the step of hot extrusion, the method comprises a treatment step, wherein the polyolefin particles are subjected to a flow of air at a temperature of between 50° C. and 150° C.

3. The method according to claim 1, wherein the polyolefin particles comprise thermoplastic polyolefin (TPO) particles.

4. The method according to claim 1, wherein the thermoplastic particles further comprise polypropylene (PP) particles, an amount of said polypropylene particles being between 5% and 40% by weight with respect to a total weight of the thermoplastic particles.

5. The method according to claim 1, wherein the thermoplastic particles further comprise low-density polyethylene (LDPE) particles, an amount of said low-density polyethylene particles being between 15% and 30% by weight with respect to a total weight of the thermoplastic particles, said LDPE particles having a melt flow index between 0.3 g and 12.0 g/10 min, and a density between 0.80 and 0.95 g/cm³.

6. A plastic web produced by a method according to claim 1.

7. The plastic web according to claim 6, having a thickness of between 0.2 mm and 1.5 mm and/or a density of at least 0.8 g/cm³.

8. A vehicle trim panel, comprising a substrate, a first support layer and a second protective layer, the first support layer being arranged between the substrate and the second protective layer, the first support layer being formed from a plastic web according to claim 6.

9. The vehicle trim panel according to claim 8, wherein the second protective layer has a thickness of between 5 μm and 50 μm.

10. The vehicle trim panel according to claim 8, wherein the second protective layer is formed from a material of a polyurethane (PU) or thermoplastic polyurethane (TPU) type, an acrylic, or a mixture of these compounds.

11. The vehicle trim panel according to claim 8, further comprising: a third layer of polyolefin foam, arranged between the first support layer and the substrate.

12. The vehicle trim panel according to claim 11, further comprising a fourth layer arranged between the third layer of polyolefin foam and the substrate, said fourth layer being made of woven or non-woven textile.

13. The method according to claim 2, wherein, in the treatment step, the thermoplastic particles are subjected to a flow of air at a temperature of between 50° C. and 150° C.

14. The method according to claim 2, wherein, in the treatment step, the thermoplastic particles are subjected to a flow of air at a temperature of between 100° C. and 120° C.

15. The method according to claim 2, wherein, in the treatment step, the polyolefin particles are subjected to a flow of air at a temperature of between 100° C. and 120° C.

16. The method according to claim 3, wherein the thermoplastic polyolefin (TPO) particles are mixed with thermoplastic vulcanized polyolefin (TPV) particles and/or thermoplastic elastomer polyolefin (TPE) particles.

17. The method according to claim 4, wherein the PP particles are at least partially derived from recycled materials.

18. The method according to claim 4, wherein the thermoplastic particles further comprise low-density polyethylene (LDPE) particles having a melt flow index between 0.5 g and 12.0 g/10 min, and a density between 0.80 and 0.95 g/cm³

19. The method according to claim 5, wherein the LDPE particles are at least partially derived from recycled materials.
